(19) United States
(12) Patent Application Publication
(10) Pub. No.: US 2002/0143910 A1
(43) Pub. Date: Oct. 3, 2002

(54) Network hub

(76) Inventors: Shih-Wei Chou, Taichung City (TW); Chih-Wen Wang, Taichung City (TW); Hung-I Tsai, Taichung City (TW)

Correspondence Address: WILDMAN, HARROLD, ALLEN & DIXON, 225 WEST WACKER DRIVE, CHICAGO, IL, 60606, US

(21) Appl. No.: 09/820,567

(22) Filed: Mar. 29, 2001

(51) Int. Cl. G06F 15/16; H04L 12/66; G06F 15/173

(52) U.S. Cl. 709/223; 709/250; 370/463

(57) ABSTRACT

A network hub is adapted for controlling connection between a server and multiple work stations in a local-area network. The network hub includes a rectifying and voltage-regulating circuit for outputting a power signal, a signal processing circuit coupled electrically to the rectifying and voltage-regulating circuit for receiving the power signal therefrom, and an output port module coupled electrically to the signal processing circuit. The signal processing circuit receives a command transmitted via an input port module connected to the server, and is operable so as to output control signals corresponding to the command from the server. The output port module has connecting ports coupled electrically to switching circuits, respectively. Each connecting port is connected to a corresponding one of the work stations via network lines. Each control signal is received by a respective one of the switching circuits so as to control conduction or cut-off thereof.

### BACKGROUND OF THE INVENTION

1. Field of the Invention

The invention relates to a network hub, more particularly to a network hub that can directly control connection between a server and a plurality of work stations in a local-area network.

2. Description of the Related Art

FIG. 1 illustrates a conventional network hub 4 that is used for interconnecting a server 1 and a plurality of work stations 2 in a local-area network via network lines 3 thereof. The conventional network hub 4 includes a plurality of connecting ports 401. Each of the server 1 and the work stations 2 is connected to a corresponding one of the connecting ports 401 via the network lines 3. Since the server 1 utilizes software to control conduction or cut-off of each of the connecting ports 401, a dedicated IP address must be assigned to each work station 2, thereby resulting in a relatively high cost. Furthermore, when any one of the work stations 2 and the server 1 connects to the Internet, the other ones of the work stations 2 and the server 1 may be accessible to hackers. Therefore, when the server 1 is invaded by a hacker, the conventional network hub 4 can be controlled by the hacker, thereby resulting in a security problem.

### SUMMARY OF THE INVENTION

Therefore, the object of the present invention is to provide a network hub that can ensure easy and safe operation and that has a relatively low cost.

According to the present invention, a network hub is adapted for controlling connection between a server and a plurality of work stations in a local-area network via network lines thereof. The network hub comprises:

a housing;

a rectifying and voltage-regulating circuit mounted in the housing and adapted to output a power signal;

an input port module mounted on the housing and adapted to be connected to the server for transmitting a command therefrom;

a signal processing circuit coupled electrically to the rectifying and voltage-regulating circuit for receiving the power signal therefrom, the signal processing circuit being further coupled electrically to the input port module for receiving the command transmitted via the input port module and being operable so as to output control signals corresponding to the command from the server; and

an output port module coupled electrically to the signal processing circuit, the output port module having a plurality of switching circuits mounted in the housing, and a plurality of connecting ports mounted on the housing and coupled electrically to the switching circuits, respectively, each of the connecting ports being adapted to be connected to a corresponding one of the work stations via the network lines, each of the control signals outputted by the signal processing circuit being received by a respective one of the switching circuits so as to control conduction or cut-off thereof.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional network hub connecting a server and a plurality of work stations;

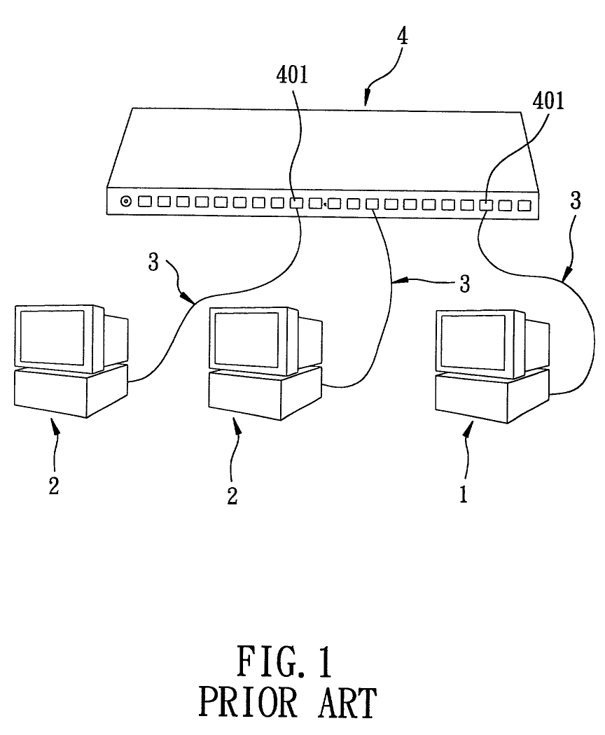

FIG. 2 is a schematic view of the preferred embodiment of a network hub according to this invention connecting a server and a plurality of work stations; and

FIG. 3 is a schematic circuit block diagram of the preferred embodiment.

### DETAILED DESCRIPTION OF THE PREFERRED EMBODIMENT

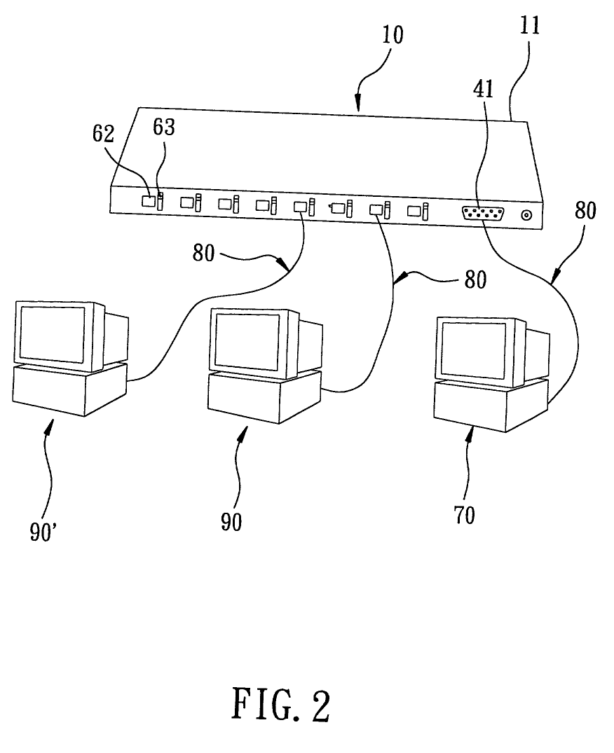

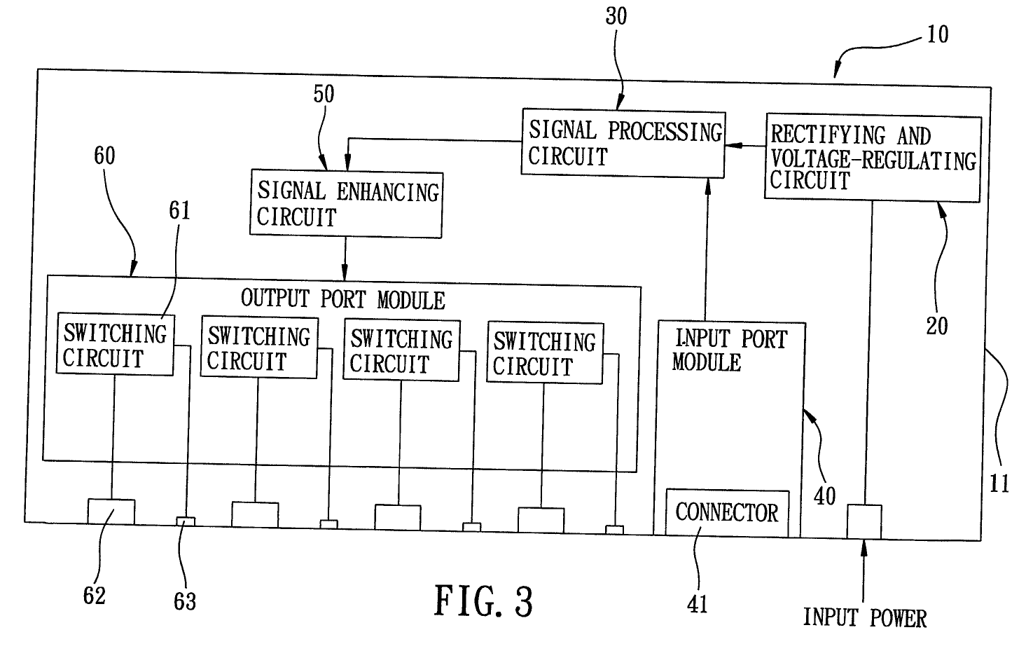

Referring to FIGS. 2 and 3, according to the preferred embodiment of this invention, a network hub 10 is adapted for controlling connection between a server 70 and a plurality of work stations 90, 90′ in a local-area network via network lines 80 thereof, and is shown to include a housing 11, a rectifying and voltage-regulating circuit 20, an input port module 40, a signal processing circuit 30, an output port module 60, and a signal enhancing circuit 50.

The rectifying and voltage-regulating circuit 20, such as a known AC-to-DC converter, is mounted in the housing 11 and is adapted to receive input power and output a power signal.

The input port module 40 is mounted on the housing 11 and includes an RS-232 connector 41. The input port module 40 is adapted to be connected to the server 70 via the RS-232 connector 41 for transmitting a command therefrom.

The signal processing circuit 30 is coupled electrically to the rectifying and voltage-regulating circuit 20 for receiving the power signal therefrom. The signal processing circuit 30 is further coupled electrically to the input port module 40 for receiving the command transmitted via the input port module 40, and is operable so as to output control signals corresponding to the command from the server 70.

The output port module 60 is coupled electrically to the signal processing circuit 30. The output port module 60 has a plurality of switching circuits 61, such as relays, mounted in the housing 11, and a plurality of connecting ports 62 mounted on the housing 11 and coupled electrically to the switching circuits 61, respectively. Each of the connecting ports 62 is adapted to be connected to a corresponding one of the work stations 90, 90′ via the network lines 80. Each of the control signals outputted by the signal processing circuit 30 is received by a respective one of the switching circuits 61 so as to control conduction or cut-off thereof. The output port module 60 further has a switch 63 coupled electrically to each of the switching circuits 61 so as to control conduction and cut-off thereof independently of the control signals from the signal processing circuit 30.

The signal enhancing circuit 50 is mounted in the housing 11 and interconnects electrically the signal processing circuit 30 and the output port module 60 for enhancing the control signals outputted by the signal processing circuit 30. More specifically, the signal enhancing circuit 50 can enhance the control signals from the signal processing circuit 30 so as to permit activation of the relays in the output port module 60.

Therefore, when a user wants to disconnect the work station 90′ from the local-area network, the user can utilize the server 70 to output a cut-off command to the signal processing circuit 30 via the input port module 40. The signal processing circuit 30 responds by outputting a cut-off control signal corresponding to the cut-off command from the server 70 to the output port module 60 so as to cut-off the switching circuit 61 corresponding to the work station 90′. Alternatively, the user can directly operate the switch 63 corresponding to the work station 90′ to cut-off the switching circuit 61 corresponding to the work station 90′.

Due to the presence of the switches in the output port module, the network hub of this invention can also be used for controlling connection between a plurality of work stations in local and wide-area networks. For example, a company has a first work station for Internet services, and a second work station for exchanging orders and cash flow and for general data transmission. Usually, the first work station communicates with the second work station via the network hub of this invention. When the second work station is used to confirm orders or cash flow, the switch corresponding to the first work station is operated to cut-off connection between the first and second work stations such that security of the second work station can be ensured.

It is noted that the network hub of this invention can indeed control connection between the server and the work stations via the command from the server and the switches such that the network hub of this invention ensures easy and safe operation at a relatively low cost. The object of the invention is thus met.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A network hub for controlling connection between a server and a plurality of work stations in a local area network via network lines thereof, said network hub comprising:
a housing;
a rectifying and voltage-regulating circuit mounted in said housing and adapted to output a power signal;
an input port module mounted on said housing and adapted to be connected to the server for transmitting a command therefrom;
a signal processing circuit coupled electrically to said rectifying and voltage-regulating circuit for receiving the power signal therefrom, said signal processing circuit being further coupled electrically to said input port module for receiving the command transmitted via said input port module and being operable so as to output control signals corresponding to the command from the server; and
an output port module coupled electrically to said signal processing circuit, said output port module having a plurality of switching circuits mounted in said housing, and a plurality of connecting ports mounted on said housing and coupled electrically to said switching circuits, respectively, each of said connecting ports being adapted to be connected to a corresponding one of the work stations via the network lines, each of the control signals outputted by said signal processing circuit being received by a respective one of said switching circuits so as to control conduction or cut-off thereof.

2. The network hub of claim 1, wherein said output port module further has a switch coupled electrically to each of said switching circuits so as to control conduction and cut-off thereof independently of the control signals from said signal processing circuit.

3. The network hub of claim 1, further comprising a signal enhancing circuit mounted in said housing and interconnecting electrically said signal processing circuit and said output port module for enhancing the control signals outputted by said signal processing circuit.
